(19) United States
(12) Patent Application Publication
(10) Pub. No.: US 2018/0144101 A1
(43) Pub. Date: May 24, 2018

(54) IDENTIFYING DIAGNOSIS-RELEVANT HEALTH INFORMATION

(71) Applicant: Microsoft Technology Licensing, LLC, Redmond, WA (US)

(72) Inventors: Hadas Bitran, Ramat Hasharon (IL); Ryen William White, Woodinville, WA (US); Shahar Yekutiel, Tel Aviv (IL); Gil Shacham, Ramat Hasharon (IL); Girish Sthanu Nathan, Sammamish, WA (US)

(73) Assignee: Microsoft Technology Licensing, LLC, Redmond, WA (US)

(21) Appl. No.: 15/359,243

(22) Filed: Nov. 22, 2016

(51) Int. Cl. G06F 19/00

(52) U.S. Cl. CPC G06F 19/3418; G06F 19/345; G06F 19/322

(57) ABSTRACT

Examples are provided for a health monitoring computing system, including a data interface configured to receive appointment data and health tracking data, the health tracking data including biometric data measured by one or more biometric sensors worn by a user, health-scheduling logic configured to determine that the user is to see a healthcare professional within a threshold period of time based at least on computer analysis of the appointment data, and appointment-optimization logic configured to generate a list of diagnosis-relevant health information based at least on computer analysis of the health tracking data. The example health monitoring computing system also includes an output device configured to present the list to the user for editing prior to an appointment with the healthcare professional.

### BACKGROUND

Individuals may visit healthcare professionals to address healthcare concerns and/or receive preventative healthcare. Information regarding an individual's recent activities and changes in routine may be relevant to a diagnosis for the individual.

### SUMMARY

Examples are provided for a health monitoring computing system, including a data interface configured to receive appointment data and health tracking data, the health tracking data including biometric data measured by one or more biometric sensors worn by a user, health-scheduling logic configured to determine that the user is to see a healthcare professional within a threshold period of time based at least on computer analysis of the appointment data, and appointment-optimization logic configured to generate a list of diagnosis-relevant health information based at least on computer analysis of the health tracking data. The example health monitoring computing system also includes an output device configured to present the list to the user for editing prior to an appointment with the healthcare professional.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a plurality of users interacting with a plurality of computing devices associated with a health platform.

FIG. 2 is a block diagram of example data flow in a health monitoring computing system for providing diagnosis-relevant information to a health agent.

FIG. 3 is a flow chart of an example method of generating a list of diagnosis-relevant information.

FIG. 4 is a flow chart of an example method of determining diagnosis-relevant information.

FIG. 5 is a block diagram of an example computing system.

### DETAILED DESCRIPTION

Various different types of health information, such as health anomalies, changes in an individual's routines, habits, and/or activities, and/or trends in an individual's or group's behaviors or physiological measureables may provide insight that is relevant to a healthcare professional providing a medical opinion. However, an individual may not be aware of or remember such health information, and/or may not know which information is relevant to the healthcare professional for providing a diagnosis or other medical opinion. The present disclosure is directed to computing systems that automatically determine when an individual is to see a healthcare professional, and automatically generate a list of diagnosis-relevant information related to the individual. The computing system is configured to automatically identify diagnosis-relevant information based on changes in the individual's lifestyle or health states. As such, the computing system assists the healthcare professional in determining a health condition of the individual by surfacing relevant information that an individual may otherwise neglect to share with the healthcare professional. Furthermore, while the computing system automatically surfaces potential information to share with the healthcare professional, the user's privacy and agency is respected, and the computing system provides the user with full control of which information is eventually shared with the healthcare professional.

As an illustrative example scenario, a trend, such as a recent increase or change in the individual's exercise activities, may be a more likely cause of an individual's muscle discomfort than a muscle-related disease. However, if the recent change in the exercise activities seems relatively minor to the individual, the individual may neglect to mention the change to the healthcare professional, thereby impeding the healthcare professional's ability to provide an informed diagnosis of the muscle discomfort. Generating a list of diagnosis-relevant information based on changes in the individual's activity and health patterns may help to ensure that the healthcare professional receives sufficient information for forming a diagnosis. Furthermore, the list may be curated by the user and/or based on other information (e.g., knowledge of a determined type of healthcare professional). For example, if the healthcare professional is a dental practitioner, anomalies or trends related to changes in exercise routines are not likely to be relevant to the individual's dental health, and thus may not be included in a list of diagnosis-relevant information.

Diagnosis-relevant information may be determined for an individual by comparing recent health data for the individual to past health data for the individual (e.g., a recent increase in sleep each night), determined “norms” or other statistical information based on information from a plurality of individuals (e.g., most users/similar users sleep [x] hours each night), and/or other third-party data (e.g., threshold number of people who traveled to a certain region experienced a similar or same symptom/contracted the same disease). Accordingly, the disclosed systems and methods may track and process data from one or more devices to determine the diagnosis relevant information.

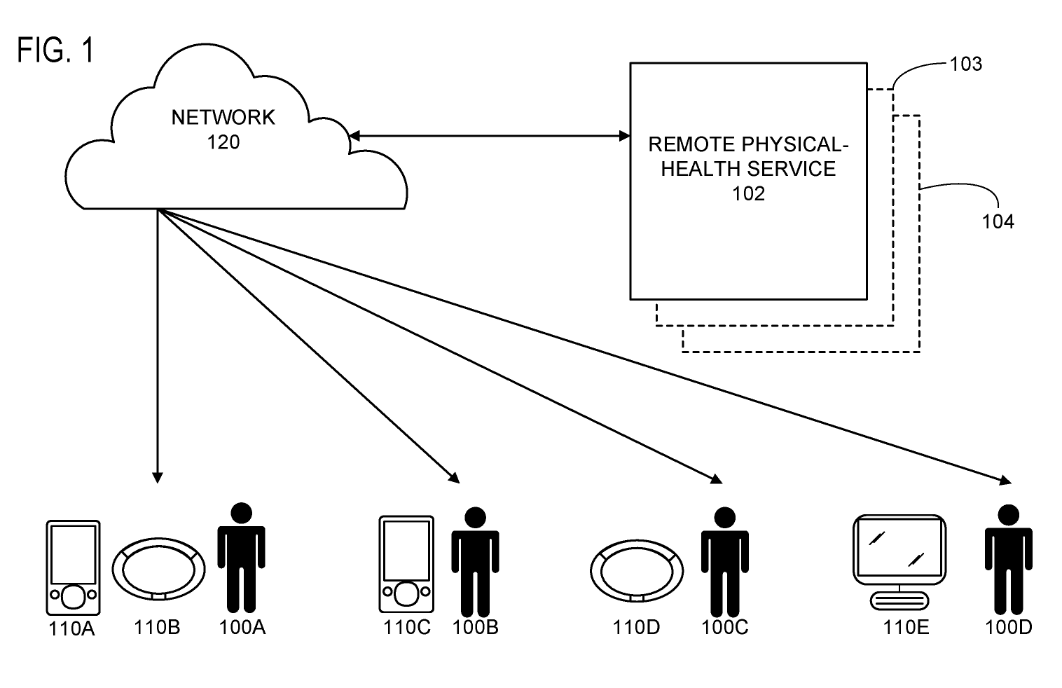

FIG. 1 schematically shows a plurality of different users 100 (e.g., User 100A, User 100B, User 100C, and User 100D). Each user may use one or more computing devices 110 (e.g., smartphone 110A, fitness watch 110B, smartphone 110C, fitness watch 110D, and personal computer 110E). A variety of different types of computing devices may be used without departing from the scope of the present disclosure; smartphones, fitness watches, and personal computers are provided as non-limiting examples. In general, each computing device 110 may be configured to monitor physical-health parameters for a user (e.g., via a biometric sensor and/or other sensors capable of monitoring user activity and status), receive information pertaining to a user, communicate with one or more physical-health services, present physical-health information to a user, and/or perform other computing functions.

The computing device 110 may include one or more logic engines for deriving information from different inputs (e.g., one or more sensors). The inputs may be processed by the logic engines implementing any suitable computer analysis, including supervised and unsupervised machine learning algorithms and/or techniques. Example machine-learning algorithms and/or techniques include, but are not limited to, exploratory factor analysis, multiple correlation analysis, support vector machine, random forest, gradient boosting, decision trees, boosted decision trees generalized linear models, partial least square classification or regression, branch-and-bound algorithms, neural network models, deep neural networks, convolutional deep neural networks, deep belief networks, and recurrent neural networks. Such machine-learning algorithms and/or techniques may, for example, be trained to determine details relating to a health appointment (e.g., time, type of appointment, health-care provider, type of health-care provider) and/or details relating to diagnosis-relevant health information (e.g., travel history, heart rate trends, diet trends, significant events, sleep patterns). The machine-learning algorithms and/or techniques may additionally or alternatively be trained to determine precursor information used by downstream logic to make further determinations. For example, upstream machine learning logic may be used to determine a user's location, and downstream machine learning logic may consider the determined location, along with other inputs, in determining a user's stress level. It is to be understood that any of the computer-implemented determinations described herein may leverage any suitable machine-learning approach, or any other computer-executed process for converting known types of input (e.g., sensor input, calendar data input, communication data input,) into appointment-relevant, anomaly/trend-relevant, and/or other health-relevant determinations.

A computing device 110 optionally may include one or more sensors configured to collect information relating to one or more measureable parameters, and the collected information may be utilized by one or more machine learning algorithms and/or techniques and/or other suitable computer analysis. As non-limiting examples, a computing device 110 may include and/or be in communication with one or more biometric sensors (e.g., heart rate monitor, blood-sugar monitor, electrodes/galvanic skin response sensor, etc.), microphones, visible-light sensors, ultraviolet sensors, ambient temperature sensors, contact sensor modules, optical sensor module, accelerometers, gyroscope, magnetometers, global positioning system (GPS) receivers, as well as any other applicable sensors

A microphone may be configured to measure the ambient sounds or sound level of a user or receive voice commands from the wearer. For example, a user may issue a voice command indicating that the computing device 110 is to begin tracking health information. The computing device may be configured to analyze the ambient sounds or sound level of the user to determine an environment and/or activity performed by the user. For example, muffled conversations and clinking dinnerware may indicate that the user is in a restaurant, while vehicle noise and footsteps may indicate that the user is walking along a street. Such indications may be determined based on computer analysis of the raw audio signals from the microphone, using one or more of the machine-learning algorithms described above or any other suitable approach. For example, patterns in recorded audio signals may be used to identify muffled conversations, clinking dinnerware, vehicle noise, and/or footsteps in the above scenarios. Any suitable features of the audio signals (e.g., frequency, amplitude, etc.) may be computer analyzed or otherwise processed by computer logic in order to identify an associated user context or environment context.

Input from a visible-light sensor, ultraviolet sensor, and ambient temperature sensor may be used to assess aspects of the wearer's environment—e.g., the temperature, overall lighting level, and whether the wearer is indoors or outdoors. Additionally or alternatively, a visible-light sensor, ultraviolet sensor, and ambient temperature sensor may be used individually or in conjunction with other sensors to determine when a user begins a new physical activity, and track aspects of the user's performance.

For example, the raw data from one or more of the above-described sensors (e.g., raw light and/or temperature signals) may be used by one or more of the machine-learning algorithms discussed above and/or any other suitable approach to determine associated contextual information. Depending on a type of temperature sensor, raw data may include a voltage, infrared light, or other reading that may be used to determine an associated temperature. For light sensors, one or more features of detected light (e.g., wavelength, energy, intensity, radiance, luminance, and/or other parameters) may be used to assess associated environmental conditions. For example, changes in light measurements over time may indicate changes in a user's activities, such as a user moving from performing an outdoor activity to an indoor activity.

An accelerometer and a gyroscope may furnish inertial and/or rotation rate data along three orthogonal axes as well as rotational data about the three axes, for a combined six degrees of freedom. This sensory data may be used to provide a pedometer/calorie-counting function, for example. Accelerometer and gyroscope data may be used by one or more of the machine-learning algorithms discussed above and/or any other suitable approach to determine information regarding a user's health and/or activities. Any suitable features of accelerometer and gyroscope data may be computer analyzed or otherwise processed by computer logic in order to identify an associated user context.

Data from an accelerometer and a gyroscope may be combined with geomagnetic data from a magnetometer to further define the inertial and rotational data in terms of geographic orientation. The wearable electronic device may include a global positioning system (GPS) receiver for determining the wearer's geographic location and/or velocity based on computer analysis of positioning signals and/or changes in positioning signals provided by the GPS receiver.

In the case where computing device 110 is a wearable computing device (e.g., fitness watches 110B and 110D), contact and optical sensor modules may be included. Such modules may be configured to directly contact and/or otherwise interface with a user's skin, and may measure a number of parameters, including skin electrical resistance and/or capacitance, skin temperature, and whether or not the computing device 110 is currently being worn. Such measurements may be used by one or more of the above-described machine-learning algorithms and/or any other suitable approach for computer analysis. For example, electrical changes on the user's skin may be detected by contact sensors and used to determine heartbeat activity. Furthermore, an optical sensor module may be used to determine blood flow through the capillaries in the skin and thereby provide a measurement of the wearer's heart rate, blood oxygen level, blood glucose level, and/or other biomarkers with optical properties.

Sensors such as those listed above may collect physical-health information for a user of a computing device 110. For example, a computing device may determine the number of steps taken by a user during a period of time (e.g., a day, a week, a single workout session, etc.), the user's heart rate at rest and/or during exercise, the number of calories burned by a user during a period of time, a user's body temperature at rest and/or during exercise, the length of time per night a user spends sleeping, the number of times per night a user wakes up, and any other information available. In some examples, computing device 110 may be configured to interpret one or more sudden changes in speed or orientation as the beginning of a workout, and begin tracking physical-health information accordingly. A GPS receiver may be used in order to determine the distance traveled by a user during a period of time (e.g., a workout comprising, walking, running, cycling, swimming, etc.).

Computing device 110 may include any number of appropriate sensors, including sensors not explicitly described herein. Information from sensors may be used in combination with information from other sources to determine a context of a user, such as determining a potential environment or activity of the user. For example, navigation information may be computer analyzed to locate the user at a particular city block, and ambient sounds recorded by a microphone may be computer analyzed to locate the user on a sidewalk, in a restaurant, in a business, at a hotel, or at another particular location on the city block based on machine learning algorithms associating different audio patterns with different locations. Heart rate information may be computer analyzed to confirm that the user's activity matches the determined location. For example, a steady heart rate indicating that the user is sleeping may confirm that the user is located in a hotel room. The examples provided above are not intended to limit the scope of the disclosure in any way. Additionally, one or more of the sensors listed above, used either individually or in conjunction, may be used to track any number of physical-health parameters while a user performs any number of activities.

In some examples, a computing device 110 may be able to receive demographic information or physical-health information from sources other than dedicated hardware sensors. For example, the computing device may include a user interface allowing a user to manually input physical-health and demographic information. The computing device may additionally include a communications subsystem, allowing the computing device to communicate with other computing devices directly via a wired connection or indirectly over a wireless computer network such as, for example, the Internet.

As such, a computing device 110 that lacks suitable sensors for physical-health information collection may still obtain physical-health information for a user. For example, a user may exercise while wearing a wearable computing device (e.g., fitness watch 110B). Data collected by the wearable computing device may be copied or transferred to one or more other computing devices such as, for example, smartphone 110A or personal computing device 110E. This may allow user to review physical-health information from any one of several computing devices, even if the computing device was not present at the time the data was collected. Additionally or alternatively, a user may manually track physical-health information for a workout or other period of activity, and manually enter such information into a computing device 110 via, for example, a user interface, a mouse and keyboard, a voice entry, and/or other suitable input method. This may allow a user who does not have access to a computing device with appropriate hardware sensors to nonetheless benefit from physical-health information storage and analysis.

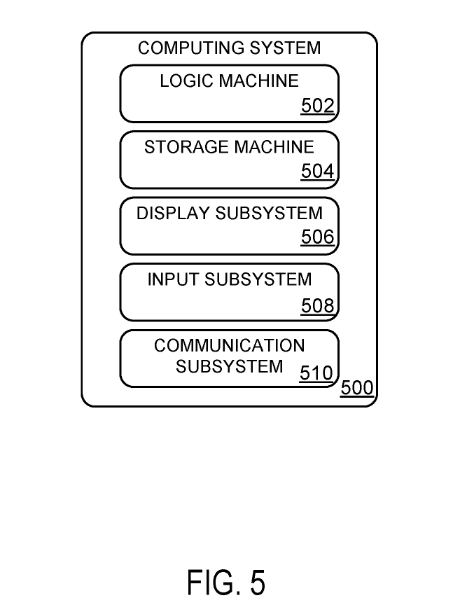

A computing device 110 may be further configured to communicate with one or more physical-health services such as, for example, remote and/or external physical-health services 102, 103, and 104. A physical-health service may be implemented as a computer in accordance with FIG. 5. In some implementations, the physical-health service may take the form of one or more stand-alone computers communicatively accessible via computing devices 110. A computing device 110 may be configured to communicate with a physical-health service 102 directly, through a wired connection, and/or indirectly, through a wireless computer network. A physical-health service may be locally located on the same user computing device that tracks and stores physical-health information for the particular user. In other examples, a physical-health service may be locally located on a companion user computing device to the device that tracks and stores physical-health information for the particular user. For example, a physical-health service may be located on a smartphone 110A that wirelessly communicates with a fitness watch 110B. In still other examples, a remote physical-health service may be located on one or more remote servers, accessible via a computing network such as, for example, network 120.

During communication with a physical-health service, a computing device 110 may upload demographic and/or physical-health information gathered and/or stored by the computing device 110 to the physical-health service for storage and/or processing. In this manner, a user may perform a physical activity while one or more computing devices (such as, for example, smartphone 110A or fitness watch 11B) collects physical-health information pertaining to the physical activity. This information may then be uploaded to and stored by the physical-health service. The information may be accessed by the uploading computing device and/or one or more other authorized computing devices. For example, a user may regularly engage in physical activities while wearing a fitness watch 110B, and still be able to access historical and/or statistical information regarding the user's physical activities from a personal computer 110E, after the personal computer retrieves the relevant information either directly from the fitness watch or from the physical-health service.

A physical-health service may be configured to collect physical-health information from a plurality of users 100, and store such information for later access. A physical-health service may additionally be configured to perform one or more processing or analysis functions on the stored physical-health data, for the purpose of providing each user of a health platform with insights relating to their physical-health relative to the physical-health of demographically similar users.

A computing device 110 may in some examples be configured to present a user with information related to the user's physical-health. Such information may be collected using one or more hardware sensors, manually input by a user, and/or received from a physical-health service. For example, a computing device 110 may be operable to provide a user with summaries of previous workouts performed, including the duration of the activity, the number of steps taken by the user, the user's maximum heart rate, the number of calories burned, and/or other exercise information. A computing device 110 may additionally be operable to provide a user with graphs, charts or other summaries, for example indicating changes in a user's weight or body mass index (BMI) over time.

While providing a user with summaries of physical activities performed may be useful, it may in some cases be more useful to provide information regarding anomalies, trends, or other information in the user's data to a healthcare professional, who may be better able to assess the information, with respect to health-related diagnoses, than the user. For example, providing a user with information about the user's resting heart rate may not be helpful if the user does not know whether the measured resting heart rate is higher or lower than recommended (e.g., than an average or advised acceptable range for demographically-similar users). A computing device or physical-health service may be configured to determine average values for various physical-health parameters for everyone in the general population and compare the user's heart rate to these averages in order to assess whether the measured heart rate constitutes an anomaly or change in a trend of historical heart rate measurements. However, this information may not be particularly helpful because many of the people in the general population have different ages, heights, weights, genders, physical activity levels, or other demographic and/or physical-health metrics. More valuable health insights may be provided by comparing aspects of a user's physical-health to other users who are demographically similar and/or to prior-monitored values for that user, allowing a healthcare professional to be informed when, for example, the user's resting heart rate is abnormal compared to a group of similar users and/or a past value/average heart rate for that user.

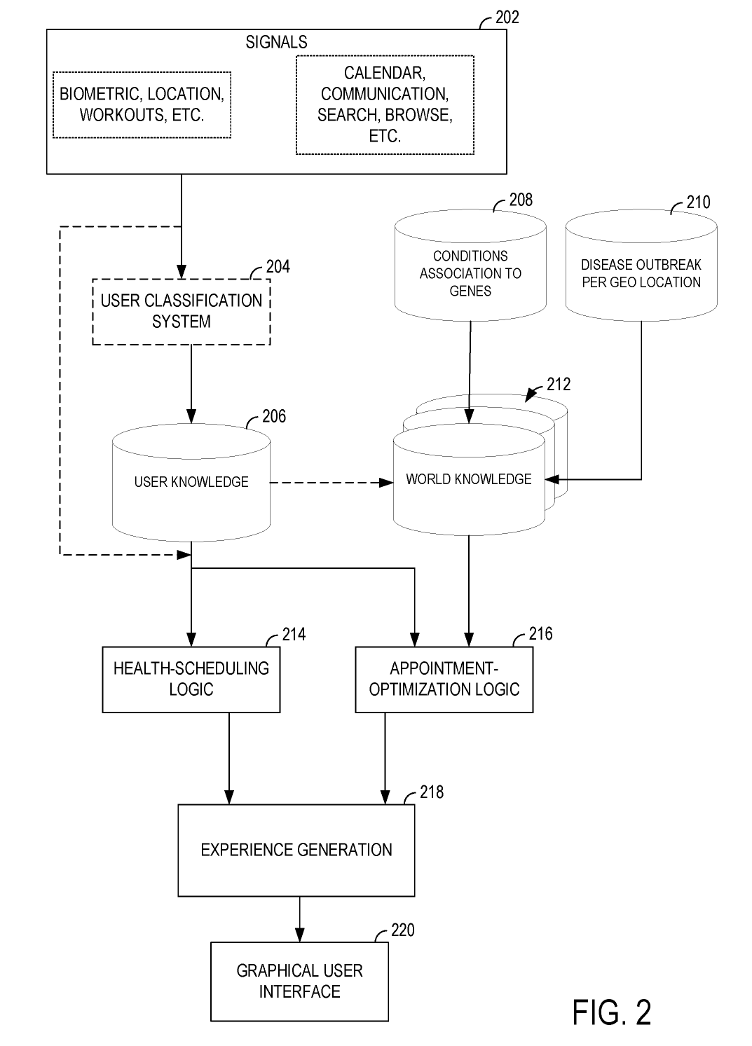

FIG. 2 is a block diagram showing data flow for providing diagnosis-relevant information to a health agent. On a first branch, user-specific information is acquired via signals from one or more computing devices, sensors, and/or other devices at 202. The signals at 202 may indicate a user demographic and/or context by providing location information, search history, workout schedules (historical, planned, and/or current), browsing data (e.g., data from web forms filled in by the user), user profile information, calendar data (e.g., scheduled appointments), communication data (e.g., recent phone calls, SMS/MMS messages, emails, etc.), and/or any other sensed or retrieved data. The signals may transfer data relating to any of the demographic or context information described above with respect to FIG. 1. In some examples, the signals may be received at regular intervals, responsive to a trigger (e.g., responsive to a determination that a user is to see a healthcare professional within a threshold period of time), and/or continuously (e.g., via real-time monitoring that provides a real-time feed of user contextual information). The signals at 202 may be provided by any suitable signal source(s), including a user's computing device (e.g., mobile phone/smartphone, tablet, laptop, wearable device, desktop computer, head-mounted display device, etc.), a central database and/or repository (e.g., a storage device located remotely from the user and in communication with one or more of the user's computing device), a server (e.g., a social networking server, a webpage host, etc.), a remote sensor (e.g., a public webcam, a traffic camera, a security camera, etc.), a computing device of a different user located in proximity to the user being tracked/monitored, and/or any other suitable signal source.

The signals at 202 may be transmitted to a user classification system 204 for processing. For example, the user classification system 204 may include one or more data processing devices for receiving signals including user data (e.g., sensed data, stored data, and/or other sources of demographic and contextual information on the user) and analyzing the signals to determine information about the user that may be relevant to diagnosing the user. For example, raw sensor data may be received at the user classification system and processed to determine a location of a user, an activity of a user, an environment of a user, a status of a user, etc. The processing may include comparing the raw sensor data to reference data indicating a given user status/environment/condition feature to determine the applicability of that user status/environment/condition being experienced by the user. In other examples, stored data indicating a user's profile may be processed by the user classification system to parse (e.g., extract and categorize) relevant demographic and/or user activity data. For example, a user profile (or updates made thereto) may be received from a social networking server or a health database (e.g., including a user's health history), and the user profile information may be parsed to pull out the user's birthdate, to determine recent user activity (e.g., based on photos including the user performing the activity and/or user-generated posts describing the activity), to identify chronic or past health conditions (e.g., based on entries in a user's health record), and/or to provide other data regarding the user. In such examples, the user classification system may recognize tags around data in order to classify data in the user's profile as being relevant particular demographic and/or contextual features. As described above with respect to FIG. 1, multiple signals from 202 may be processed in relation to one another by user classification system 204 to provide confirmation of user demographic and/or contextual information.

Processed data from the user classification system 204 may be transmitted to user knowledge repository 206. User knowledge repository 206 may include one or more storage devices (e.g., provided locally to a computing device and/or distributed amongst different computing devices and/or locations) storing user demographic and contextual information. In this way, the signals at 202 may provide the data used by the user classification system 204 to determine user demographic and contextual information, which is then stored in the user knowledge repository 206 for retrieval. It is to be understood that some or all of the signal data may bypass the user classification system and be stored directly in the user knowledge repository 206 (e.g., without being processed). In still other examples, the signals 202 may be passed directly to downstream processing modules (e.g., health-scheduling logic and appointment-optimization logic, described below) without processing the signals at the user classification system 204 and/or without storing the signals/processed signals at the user knowledge repository 206.

A second branch of the data flow in FIG. 2 relates to global and scientific data. Genetic repository 208 stores information relating conditions to genes, while outbreak repository 210 stores information relating detected disease outbreaks to geographic locations. The data stored in repository 208 may be continually updated as links between different conditions and human genes are discovered. In some examples, repository 208 may be fed data from the National Center for Biotechnology Information (e.g., Online Mendelian Inheritance Man, SNIP database, etc.), the 1000 Genomes database and/or any other genetic information resources in order to maintain up-to-date information regarding genetic links to conditions. Outbreak repository 210 may be fed data from monitoring agencies, such as the Center for Disease Control, to maintain up-to-date information regarding historical and current (e.g., real-time) outbreaks of diseases around the world. Other databases and/or repositories may be accessed in this branch of the data flow, including food recall repositories (e.g., tracking food recalls around the world), weather, emergency, and/or natural disaster repositories (e.g., storing information regarding volcano eruptions or wildfires that may affect air quality and cause health problems for users), and/or other global event/scientific repositories.

The information from the above-described repositories may be provided to a world knowledge repository 212 for storing global event/scientific information that is relevant to identifying potential causes for health issues. In this way, the world knowledge repository 212 may store only a portion of the information stored in the connected repositories. The world knowledge repository 212 may receive and store data from the user knowledge repository 206 (e.g., from user knowledge repositories of each user included in and/or subscribed to the physical-health service). The data provided to the world knowledge repository from each user knowledge repository may only be provided if a user “opts-in” to sharing his/her data (e.g., approves the transfer and use of the data). In order to provide security for the data from the user knowledge repositories, the data may be encrypted for transmission and/or storage and anonymized to prevent tracking the received data back to the particular user with which the data is associated. If the user does not provide consent to transfer the data from his/her user knowledge repository to the world knowledge repository, the user may be able to remain a part of the physical-health system without contributing such personal information.

The information stored in the world knowledge repository 212 may be organized in any suitable manner. For example, users may be grouped based on shared demographic and/or contextual information as described above with respect to FIG. 1. As illustrated in FIG. 2, world knowledge repository 212 may include multiple repositories, databases, and/or other data storage and retrieval structures, and each repository (e.g., storage device or logical division of a storage device) may be provided for a different group or set of groups of users in some examples. Additionally or alternatively, each repository (e.g., storage device or logical division of a storage device) may store information regarding one or a subset of demographic or contextual features (e.g., a different repository for each age group, each feature relating to food consumption, etc.).

The information from the user knowledge repository 206 may be provided to a health-scheduling logic 214. The user knowledge repository 206 may be local to the health-scheduling logic 214 and/or located in one or more storage devices that are accessible by the health-scheduling logic. The health-scheduling logic may evaluate the information from the user knowledge repository 206 to determine whether the user is to see a healthcare professional within a threshold period of time from a current time (e.g., within a month, within a week, within a day, etc.). For example, the health-scheduling logic may evaluate calendar and/or communication data for the user (e.g., from a calendar application and/or a communication application) to determine whether an appointment with a healthcare professional is scheduled within a threshold range of dates/time (e.g., from a current date/time). The calendar data may identify a user's past, present, and/or future scheduled events. Calendar data may additionally identify a time of day, a day of the week/month, a month of the year, a season of the year, a year, and/or any other temporal data. The calendar data may be stored in one or more calendar repositories for retrieval by the user's computing device and/or an intermediary device. In some examples, the user may utilize different calendars that are stored and/or accessed from different locations. For example, a user may have a work calendar showing work-related appointments, travel itineraries, etc., a personal calendar showing personal appointments, travel itineraries, etc., and a friend/family member/work contact's calendar showing the friend/family member/work contact's appointments, travel itineraries, etc. Communication data may indicate recently received phone calls, text messages, emails, and other communications, which may be parsed to extract and analyze information identifying an upcoming healthcare appointment for the user. For example, the text and/or voice data from a received phone call/message may be computer-evaluated using machine-learning algorithms and/or techniques, or other suitable methods, to determine whether a healthcare professional and/or health-related appointment is identified.

The health-scheduling logic may also determine a date and time of future healthcare-related appointments and set timers to trigger the performance further analysis (e.g., generate and display a list of diagnosis-relevant information, as will be described below) at a time near the future healthcare-related appointments (e.g., one day before, the night before, the morning of, one hour before, etc.).

The health-scheduling logic 214 may also evaluate the data from the user knowledge repository 206 and/or data from other sources to determine a type of healthcare professional that the user is to see. For example, a calendar entry for a healthcare appointment (e.g., including a date and/or time of the healthcare appointment) may provide an address that may be compared to public records to determine a type of healthcare practice located at the address. In other examples, an indication of the type of healthcare professional may be provided in the appointment listing and/or in a received communication reminding the user of a date and/or time of an upcoming appointment. In still other examples, the health-scheduling logic may access historical data to determine patterns of healthcare-related visits to determine a likely type of healthcare professional that the user is to see at a particular time of day, year, etc. (e.g., the user may typically visit a dentist every six months on a Monday morning, so an appointment that is scheduled for a Monday morning that is approximately [e.g., within a week or two] six months after a last recorded dentist appointment may be determined to be a dentist appointment).

Information from the user knowledge repository 206 and the world knowledge repository 212 may be provided to an appointment-optimization logic 216. Appointment-optimization logic 216 may analyze the data from the user knowledge repository 206 and the world knowledge repository 212 to determine correlations between the data and determine information that may be considered to be diagnosis-relevant (e.g., given data personalized for that user and/or up-to-date information for a population). In some examples, the appointment-optimization logic may receive signals from different or additional sources than those used to provide input to the health-scheduling logic. For example, the health-scheduling logic may receive inputs from a first device executing a calendar application and/or a communication application(s) (e.g., an email application, a messaging application, and/or a phone application), while the appointment-optimization logic may receive inputs from a wearable device (e.g., a different device than the first device) measuring biometric data from the user. For example, prior to or without receiving any sort of input from a user, the appointment-optimization logic 216 may evaluate the user's data from the user knowledge repository 206 in light of data from the world knowledge repository 212 to determine changes in the user's data that are likely to be relevant to health conditions experienced by the user.

For example, travel outside of a home region of the user may be compared to locations indicated in the disease outbreak repository 210 to determine if the user visited a location that has experienced a disease outbreak. As another example, a sleep pattern of the user may be compared to past sleep patterns to determine whether the user has recently experienced a change in total amount of sleep, quality of sleep (e.g., interruptions, tossing and turning, heart rate changes, teeth grinding, etc. during sleep), and/or other sleep-related factors. Changes above an associated threshold (e.g., where each user pattern, habit, etc. may have a different associated threshold) may be determined to be diagnosis-relevant information for that user.

The determined diagnosis-relevant information may be presented to a user via an experience generated by experience generation engine 218. For example, experience generation unit 218 may be a user interface generation unit configured to generate display data and or interface information for providing user-interactive health agent. The generated experience, including an editable list of diagnosis-relevant information may be output to a graphical user interface (GUI) 220 displayed on a display of a computing device associated with the user or otherwise presented to the user (e.g., as audio, haptic feedback, etc.). The order of the health conditions may be based on an estimated likelihood that the user has the condition, the seriousness of the condition, the rarity of the condition, and/or any other suitable ranking system. Although described as being presented via a display device, it is to be understood that the list may additionally or alternatively also be presented in a similar manner to those described herein via another presentation or output device, such as a speaker (e.g., as audio) or haptic feedback device e.g., as haptic output, such as vibration). For example, the user may wear headphones and/or an earbud during a healthcare appointment, and the list may be output to the user via the headphones/earbud at particular times during the appointment (e.g., responsive to an input from the user, at a predetermined time relative to the start of the appointment, responsive to detecting a keyword spoken—e.g., a request from the healthcare professional for indications of recent changes/trends/anomalies of which the user is aware, etc.) or prior to the appointment (e.g., while traveling to the appointment or getting ready for the appointment, etc.).

The display device used to display the GUI 220 may include a touch-sensitive display of a mobile device in one example. In other examples, the display device may include a monitor of a laptop or desktop computer (e.g., configured to accept input via a mouse, a keyboard, voice command, and/or another input device), a display of a wearable device (e.g., a smart watch, a head-mounted display device, etc.), a projector, a television (e.g., coupled to an entertainment device such as a home theatre system or a video gaming system), and/or any other suitable display device. In some examples, the display device presenting the GUI may be integrated with the device housing the health-scheduling logic 214 and/or the appointment-optimization logic 216. In other examples, the display device presenting the GUI may be in communication with the logics 214 and 216.

The GUI 220 may provide any combination of graphical elements, textual elements, and user input regions (e.g., which may be mapped to one or more of the graphical and textual elements). The user interface may include one or more selectable menu options for navigating different features of the user interface (e.g., to view different lists of diagnosis-relevant information [e.g., for different types of healthcare professionals], to sort a list of diagnosis-relevant information [e.g., by date, alphabetical, perceived significance/importance, etc.], to edit a list of diagnosis-relevant information [e.g., to add or remove information from the list], to share the list of diagnosis-relevant information [e.g., to send to a healthcare professional], and/or to otherwise interact with the list). The information displayed in the list and/or menus may be different depending on the intended recipient, such that a first view or output of the diagnosis-relevant information is presented to the user and a second, different view or output of the diagnosis-relevant information is presented to the healthcare professional. For example, a healthcare recipient may be shown or otherwise presented a list of factual information (e.g., anomalies and/or trends) and likely diagnoses, while a user may just be shown or otherwise presented the factual information (e.g., anomalies and/or trends). In some examples, a list of diagnosis-relevant information presented via the GUI 220 or otherwise presented to the user (e.g., as audio) may provide nested levels of details regarding the information.

For example, the list may show or otherwise output a plurality of diagnosis-relevant anomalies/trends and/or other diagnosis-relevant information, including a short identifier of each item of information. Responsive to input selecting a selected item of diagnosis-relevant information (e.g., a selected diagnosis-relevant anomaly, trend, or other information), a user/healthcare professional may be able to see more information regarding that diagnosis-relevant health information and/or take other actions on the diagnosis-relevant health information. For example, an anomaly or trend in the list may be initially identified as a “recent change in exercise.” Responsive to selecting that anomaly or trend, details regarding the change in exercise may be displayed. Such details may include a date/date range when the anomaly or trend occurred (e.g., exercise over the last week has been different than exercise in the prior three months, or the user performed a new exercise routine last Thursday), an identification of the change in user patterns/habits associated with that anomaly or trend (e.g., the user switched from a cardio-focused exercise routine to a weight training exercise routine, or the user exercised one more day a week for the past two weeks), information regarding the reason the change was considered to be an anomaly or significant trend (e.g., the user added an exercise routine that increased total exercise time by more than 30 minutes a day, or the user's average heart rate increased by more than 15% in the last week), and/or other details. As another example, the list may be displayed (e.g., initially and/or responsive to a menu selection) as a summary for the healthcare professional such that the healthcare professional is able to obtain a quick overview of the user's anomalous behavior and/or changes in trends.

The list may be presented via the GUI responsive to user request (e.g., voice input asking the device to remind the user of what he/she should mention to his/her doctor) and/or automatically based on a determination of an upcoming appointment by the health-scheduling logic 214. For example, the health-scheduling logic may monitor signal data to determine when an appointment is scheduled to occur within a threshold period of time (e.g., within twenty-four hours of a current time, or at the time of the appointment). In some examples, the relative time to generate and/or present the list may be based on the time and/or date of the appointment. For example, if the appointment is in the morning, the list may be generated and/or presented the night before the appointment (e.g., twelve hours before the appointment or at a specified night time, such as 8 pm). If the appointment is in the afternoon, the list may be generated and/or presented the morning of the appointment (e.g., 6 hours before the appointment or at a specified morning time, such as 8 am). Once the health-scheduling logic determines that a user is to see a healthcare professional, the health-scheduling logic may trigger the experience generation unit 218 to generate a list (e.g., a list being maintained by appointment-optimization logic 216) of diagnosis-relevant information for display via GUI 220 and/or for presentation via another output device (e.g., a speaker).

As a detailed example, a female user may see a physician with a complaint about pain in the leg. The user may not be aware of the relevance of any recent activity to the pain in the leg, and thus may not provide the physician with sufficient contextual data regarding her recent activities. The physician may thus diagnose the user with a strained muscle, since such a diagnosis may be the most common source of the user's symptoms (e.g., muscle pain in the leg). However, the user's recent activity may reveal the real cause of the muscle pain in the leg. For example, the user may have been on several long flights in the past week, and missed her regular workout routine multiple times in the past week. Signals from the user's location-aware devices (e.g., a wearable device and/or a mobile device with a GPS sensor) may be used to determine that the user traveled long distances, and the user's activity trackers (e.g., biometric sensors and/or movement sensors in wearable devices) may reveal that that user did not work out in the last week and had long periods of sitting still (e.g., while on the long flights). This data may be compared to the user's historical data (e.g., information regarding past travel and workout routines) by an appointment-optimizer logic to determine that each of the travel and the missed workouts constitute diagnosis-relevant information.

Presenting such information to the physician would enable the physician to recognize that the probability of the muscle pain is less likely to be a strained muscle and more likely to be deep vein thrombosis (DVT). In this way, the personalized processing of data from multiple signal sources may be used to generate a list of diagnosis-relevant information for presentation to a healthcare professional. Such presentation may enable the healthcare professional to provide a more effective discovery of serious medical issues than relying on only information that the patient-/user believes to be relevant. The appointment-optimization logic in this disclosure uses information from multiple sources (e.g., wearable device signals, historical user activity repositories, etc.) to personalize a list of health information for a particular user, such that health information that is most relevant to a potential diagnosis for that user is included in the list.

The health-scheduling logic 214 may also provide, to the experience generation unit 218, an indication of the type of healthcare professional to be seen by the user. Based on this indication, the experience generation unit 218 may control the appointment-optimization logic to tailor the list of diagnosis-relevant information to the determined type of healthcare professional (e.g., to include only targeted diagnosis-relevant information that is relevant to that type of healthcare professional). The determination of health information that is relevant to a specific type of healthcare professional may be based on one or more repositories of health conditions and related causes. For example, the repository/repositories may indicate types of activities, biometric data, and/or other data that may be relevant to different types of health conditions (e.g., high blood sugar can cause tingling sensations in hands, feet, and legs). The effects of determined health information may be compared to conditions treated by a type of healthcare professional that the user is planning to visit in order to determine which health information is relevant to conditions that are typically treated by that type of healthcare professional. Only that health information that is relevant to conditions that are typically treated by a type of healthcare professional are included in a presented list of diagnosis-relevant information when the user is to see that type of healthcare professional.

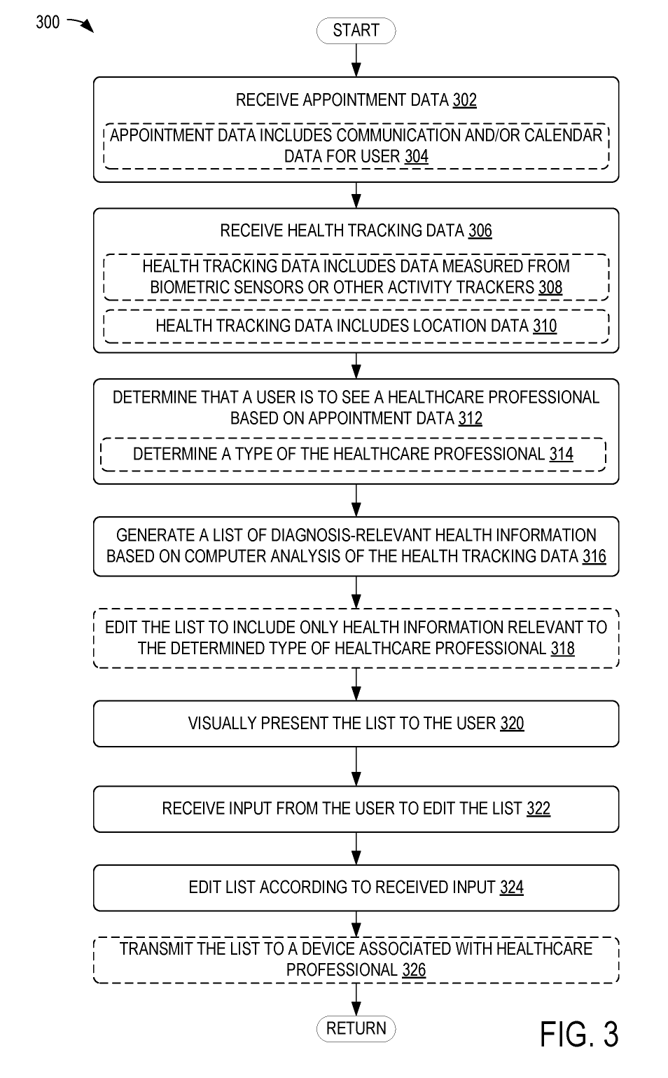

FIG. 3 shows a flow chart of an example method 300 of generating a list of diagnosis-relevant information relating to a user's health. Method 300 may be performed on a suitable computing device, such as one or more of devices 110A-110E of FIG. 1, and/or another computing device associated with a user. At 302, the method includes receiving appointment data. The appointment data may be received from an application executed on the computing device performing the method 300 and/or from another computing device or repository via a direct communication link and/or a computer network. For example, as indicated at 304, the appointment data may include communication and/or calendar data for a user (e.g., from a communication and/or calendar application executing on a computing device), web browsing information (e.g., a web lookup of a healthcare professional, address, phone number, or other information included in an appointment reminder or calendar entry), social networking information (e.g., a social networking profile for a healthcare professional indicated in an appointment reminder or calendar entry), and/or other information that may be analyzed to determine information regarding a healthcare appointment.

At 306, the method includes receiving health tracking data. In some examples, the health tracking data may be received from one or more sensors integrated in and/or in direct communication with (e.g., via a direct wired or wireless communication link) the computing device performing method 300. For example, as indicated at 308, the health tracking data may include data measured from biometric sensors or other activity trackers. Health tracking data may additionally or alternatively be received from one or more repositories (e.g., user knowledge repository 206 and/or world knowledge repository 212 of FIG. 2) via a computer network. For example, as indicated at 310, the health tracking data may include location data (e.g., location data from a GPS sensor local to the computing device performing method 300 and/or location data from a repository that stores historical location data for the user).

At 312, the method includes determining that a user is to see a healthcare professional based on appointment data. For example, the appointment data may be used by one or more machine-learning algorithms and/or other computer analysis techniques, such as the health-scheduling logic 214 of FIG. 2, to determine whether the user has an upcoming healthcare appointment scheduled. As indicated at 314, the method may further include determining a type of the healthcare professional. For example, the computer analysis described above may use particular features of the appointment data (e.g., original sender of communications, location data for appointments scheduled in calendar, etc.) to determine the type of healthcare professional.

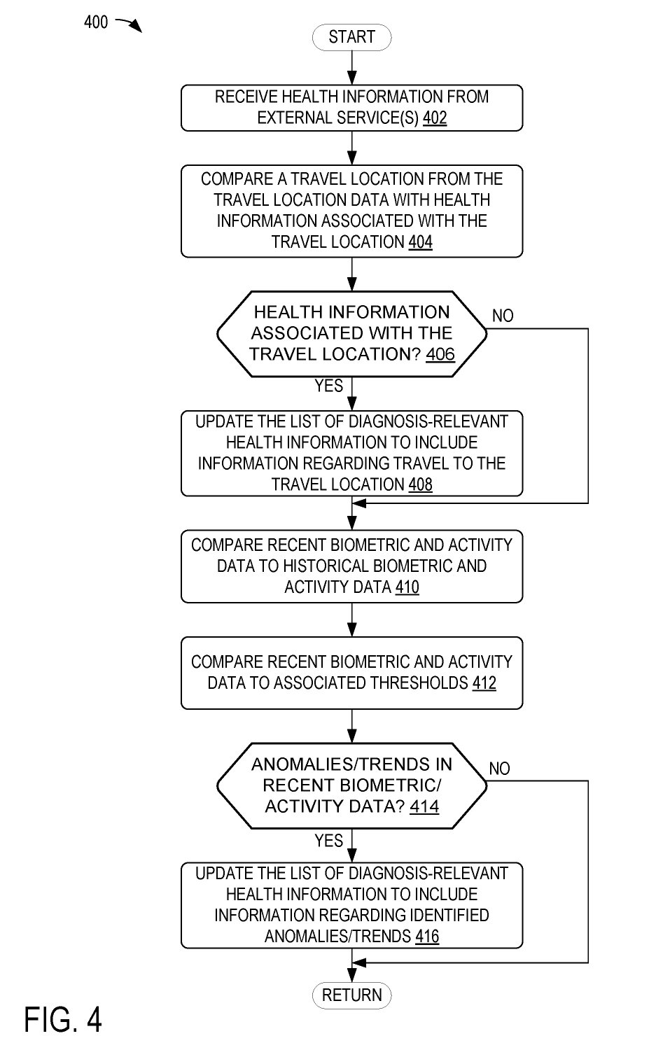

At 316, the method includes generating a list of diagnosis-relevant health information based on computer analysis of the health tracking data. For example, the health tracking data may be used by one or more machine-learning algorithms and/or other computer analysis techniques, such as appointment-optimization logic 216 of FIG. 2, to determine the list of diagnosis-relevant health information included in the generated list. Example computer analysis of the health tracking data is described below in FIG. 4. As described therein, the list may be edited to remove health information that is not relevant to the user depending on the user's demographics, interests, physical activity profile, etc. At 318, the method optionally includes editing the list to include only health information relevant to the determined type of healthcare professional. For example, the determined type of healthcare professional may be used in a machine-learning algorithm or other suitable computer analysis to eliminate health information that is not relevant to that type of healthcare professional from the list of diagnosis-relevant health information.

At 320, the method includes visually presenting the list to the user. For example, the list may be presented on a display device integrated in and/or in direct communication with the computing device performing the method 300. At 322, the method includes receiving input from the user to edit the list. For example, a user may provide input requesting that diagnosis-relevant health information included in the list to be removed from the list (e.g., to reduce the list). As another example, the user may provide input requesting an additional diagnosis-relevant anomaly to be included in the list (e.g., to expand the list). The user may enter the anomaly and/or select the anomaly from a list of anomalies determined by the computer analysis to not be relevant and/or to not be relevant to a given type of healthcare professional.

At 324, the method includes editing the list according to the received input. For example, if the user requested to remove items from the list, the list may be edited to include fewer items (e.g., to remove the items requested to be removed via user input). If the user requested to add items to the list, the list may be edited to include more items (e.g., to add the items requested to be added via user input).

At 326, the method optionally includes transmitting the list (e.g., the edited list) to a device associated with a healthcare professional. For example, the user may choose to present the list to the healthcare professional via the same display that was used to visually present the list to the user at 320. However, if the healthcare professional is to keep a copy of the list or otherwise would like to view the list differently, the list may be transmitted as indicated at 326. For example, the list may be transmitted to a device of the healthcare professional (e.g., a smartphone, laptop, tablet, patient monitoring device, office computing device, etc.) for display on the device.

It is to be understood that the list of diagnosis-relevant information may be presented to the user and the healthcare professional in any suitable order prior to and/or during an appointment with the healthcare professional. In some examples, where the user has opted in or otherwise given permission for such actions to occur, the list of diagnosis-relevant information may be transmitted to or otherwise presented to a healthcare professional (e.g., a healthcare professional associated with a user's appointment or a healthcare professional that is unassociated with a user's appointment, such as an emergency health service) prior to being presented to the user (e.g., in an emergency situation, such as when a heart monitoring signal indicates that the user is having a heart attack or a pulse monitoring signal indicates that the user no longer has a pulse). In other examples, the list of diagnosis-relevant health information (e.g., edited by the user or prior to editing by the user) may be presented to the user and the healthcare professional simultaneously.

FIG. 4 is a flow chart of an example method 400 for determining diagnosis-relevant information to be included in a list. For example, method 400 may be performed prior to 316 of method 300 of FIG. 3 in order to determine the anomalies to be included in the list referenced therein. Method 400 may be performed by appointment-optimization logic, such as appointment-optimization logic 216 of FIG. 2 in some examples. Accordingly, method 400 may be performed using data received from a user knowledge repository (e.g., user knowledge repository 206 of FIG. 2) and a world knowledge repository (e.g., world knowledge repository 212 of FIG. 2), such as the data received at 302 through 310 of method 300 of FIG. 3. The received data may include travel location data, appointment-related data (e.g., a type of healthcare professional that the user is to see), biometric data, activity data, and/or other information regarding the user and the user's health.

At 402, the method includes receiving health information from one or more external services. For example, the health information may include health trend or other data relating to a particular location (e.g., based on health information for individuals who are located in and/or traveled to the location). At 404, the method includes comparing a travel location from the travel location data (e.g., identified in the health tracking or other user data at 306/310 of FIG. 3) with health information associated with the travel location. For example, as described above, third-party monitoring services, such as the Center for Disease Control may track outbreaks of diseases in different locations. At 404, the locations to which a user has traveled may be compared with the locations indicated to have associated disease outbreaks by a third-party monitoring service. At 406, the method includes determining if there is any health information (e.g., health trends) associated with the travel location. If there is health information associated with the travel location (e.g., “YES” at 406), the method proceeds to 408 to update a list (e.g., generate a list if this is the first item of diagnosis-relevant information, or add to the list if other information has been included in the list) of diagnosis-relevant health information to include information regarding travel to the travel location. For example, the list may identify the travel location and/or identify the disease reported as breaking out in the travel location. A disease outbreak may be considered to be a health trend when a number of cases recorded as breaking out in a region within a certain period of time is greater than a threshold (e.g., a threshold indicating a statistical significance for that disease). If there is no health information associated with the travel location (e.g., “NO” at 406), the method bypasses 408 and proceeds to 410 without adding to the list of diagnosis-relevant information. Although referred to as a single travel location for illustrative purposes, it is to be understood that 404 through 408 may be performed for multiple travel locations (e.g., each travel location indicated in the travel location data for the user—each travel location to which the user has traveled in a threshold period of time, where the threshold period of time may be based on factors such as a life cycle of diseases currently indicated to be breaking out in locations of the world).

At 410, the method includes comparing recent biometric and activity data to historical biometric and activity data for the user. At 412, the method includes comparing recent biometric and activity data to associated thresholds (e.g., averages or norms for a demographically-similar group of users). At 414, the method includes determining if there are anomalies in the recent biometric and/or activity data. If there are anomalies in the recent data (e.g., “YES” at 414), the method proceeds to 416 to update the list of diagnosis-relevant health information to include information regarding the identified anomalies. If there are no anomalies in the recent data (e.g., “NO” at 416), the method bypasses 416 and returns to continue monitoring health data without updating the list of diagnosis-relevant information.

By comparing continuously-monitored user demographic and/or contextual data (e.g., user activities, patterns, etc.) to health trends for a user and/or similar users in the general population, the described systems may determine anomalies that may help a healthcare professional diagnose symptoms experienced by the user. An informed, personalized list of diagnosis-relevant information may be provided to a user without the user providing any extra information, as the logic may sift through the collected demographic and/or contextual data to determine the relevance of the data to the user and/or the healthcare appointment and generate diagnosis-relevant information. The list of diagnosis-relevant information may provide more information to healthcare professional than a typically able to be provided solely by patient reporting. For example, the user may not remember or report a recent change in routine, however sensor data may indicate such a change that is relevant to the diagnosis of a condition.

In some embodiments, the methods and processes described herein may be tied to a computing system of one or more computing devices. In particular, such methods and processes may be implemented as a computer-application program or service, an application-programming interface (API), a library, and/or other computer-program product.

FIG. 5 schematically shows a non-limiting embodiment of a computing system 500 that can enact one or more of the methods and processes described above. Computing system 500 is shown in simplified form. Computing system 500 may take the form of one or more personal computers, server computers, tablet computers, home-entertainment computers, network computing devices, gaming devices, mobile computing devices, mobile communication devices (e.g., smart phone), and/or other computing devices. Computing system 500 includes a logic machine 502 and a storage machine 504. Computing system 500 may optionally include a display subsystem 506, input subsystem 508, communication subsystem 510, and/or other components not shown in FIG. 5.

Logic machine 502 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remote accessible, networked computing devices configured in a cloud-computing configuration.

Storage machine 504 includes one or more physical devices configured to hold instructions executable by the logic machine to implement the methods and processes described herein. When such methods and processes are implemented, the state of storage machine 504 may be transformed—e.g., to hold different data.

Storage machine 504 may include removable and/or built-in devices. Storage machine 504 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 504 may include volatile, non-volatile, dynamic, static, read/write, read-only, random-access, sequential-access, location-addressable, file addressable, and/or content-addressable devices.

It will be appreciated that storage machine 504 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 502 and storage machine 504 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “logic,” and “engine” may be used to describe an aspect of computing system 500 implemented to perform a particular function. In some cases, a module, logic, or engine may be instantiated via logic machine 502 executing instructions held by storage machine 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “logic,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 506 may be used to present a visual representation of data held by storage machine 504. This visual representation may take the form of a graphical user interface (GUI). As the herein described methods and processes change the data held by the storage machine, and thus transform the state of the storage machine, the state of display subsystem 506 may likewise be transformed to visually represent changes in the underlying data. Display subsystem 506 may include one or more display devices utilizing virtually any type of technology. Such display devices may be combined with logic machine 502 and/or storage machine 504 in a shared enclosure, or such display devices may be peripheral display devices.

When included, input subsystem 508 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 510 may be configured to communicatively couple computing system 500 with one or more other computing devices. Communication subsystem 510 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 500 to send and/or receive messages to and/or from other devices via a network such as the Internet.

Another example provides for a health monitoring computing system, including a data interface configured to receive appointment data and health tracking data, the health tracking data including biometric data measured by one or more biometric sensors worn by a user, health-scheduling logic configured to determine that the user is to see a healthcare professional within a threshold period of time based at least on computer analysis of the appointment data, appointment-optimization logic configured to generate a list of diagnosis-relevant health information based at least on computer analysis of the health tracking data, and an output device configured to present the list to the user for editing prior to an appointment with the healthcare professional. In such an example, the appointment data may additionally or alternatively be received from a first device executing one or more of a calendar application, an email application, a messaging application, and a phone application. In such an example, the list of diagnosis-relevant health information may additionally or alternatively include only diagnosis-relevant health information determined to be relevant for the user based on computer analysis of one or more of user demographics, historical health data for the user, and user preferences. In such an example, the health-scheduling logic may additionally or alternatively be further configured to determine a type of the healthcare professional based at least on computer analysis of the appointment data. In such an example, the list of diagnosis-relevant health information may additionally or alternatively include only diagnosis-relevant health information determined to be relevant for the determined type of healthcare professional that the user is to see. In such an example, the data interface may additionally or alternatively be further configured to receive health information from one or more external services, and the health tracking data may additionally or alternatively include travel location data measured by one or more location sensors associated with the user. In such an example, the computer analysis of the health tracking data may additionally or alternatively include comparing a travel location from the travel location data with health information associated with the travel location. Any or all of the above-described examples may be combined in any suitable manner in various implementations.

Another example provides for, on a health monitoring computing system, a method including receiving, via a data interface of the health monitoring computing system, appointment data and health tracking data, determining, with health-scheduling logic of the health monitoring computing system, that a user is to see a healthcare professional within a threshold period of time based at least on computer analysis of the appointment data, generating, with appointment-optimization logic of the health monitoring computing system, a list of diagnosis-relevant health information based at least on computer analysis of the health tracking data, and presenting, with an output device of the health monitoring computing system, the list to the user for editing prior to or during an appointment with the healthcare professional. In such an example, the method may additionally or alternatively further include receiving, via a data interface of the health monitoring computing system, health information from one or more external services, and the health tracking data may additionally or alternatively include travel location data measured by one or more location sensors associated with the user. In such an example, the computer analysis of the health tracking data may additionally or alternatively include comparing a travel location from the travel location data with health information associated with the travel location. In such an example, the method may additionally or alternatively further include determining a type of healthcare provided by the healthcare professional based at least on computer analysis of the appointment data. In such an example, the computer analysis of the health tracking data may additionally or alternatively include determining targeted diagnosis-relevant health information that is relevant to the determined type of healthcare provided by the healthcare professional, and the list of diagnosis-relevant health information may additionally or alternatively include the targeted diagnosis-relevant health information. In such an example, the method may additionally or alternatively further include removing selected diagnosis-relevant health information from the list based at least on receiving user input requesting removal of the selected diagnosis-relevant health information. In such an example, the method may additionally or alternatively further include adding diagnosis-relevant health information to the list based at least on receiving user input requesting addition of the diagnosis-relevant health information. In such an example, the method may additionally or alternatively further include receiving user input selecting diagnosis-relevant health information and displaying additional information regarding the selected diagnosis-relevant health information. In such an example, the additional information may additionally or alternatively include measured sensor data that, upon computer analysis, was determined to indicate the selected diagnosis-relevant health information. In such an example, the additional information may additionally or alternatively include a comparison of the measured sensor data to one or more of historical data for the user and average data for a plurality of other users. Any or all of the above-described examples may be combined in any suitable manner in various implementations.

Another example provides for a health monitoring computing system including a data interface configured to receive appointment data for a user, health tracking data for the user, and health trend data for a plurality of other individuals, the health tracking data including biometric data measured by one or more biometric sensors worn by a user and travel location data measured by one or more location sensors associated with the user, health-scheduling logic configured to determine that a user is to see a healthcare professional within a threshold period of time and to determine a type of the healthcare professional based at least on computer analysis of the appointment data, appointment-optimization logic configured to generate a list diagnosis-relevant health information determined to be relevant for the determined type of healthcare professional that the user is to see based at least on computer analysis of the health tracking data, the computer analysis of the health tracking data including comparing a travel location from the travel location data with health information associated with the travel location, and an output device configured to present the list prior to or during an appointment with the healthcare professional. In such an example, the data interface may additionally or alternatively be further configured to transmit the list to a healthcare professional device. In such an example, the list may additionally or alternatively be visually presented including a first view of the diagnosis-relevant information when presented to the user and the list may additionally or alternatively be visually presented including a second, different view of the diagnosis-relevant information when presented to the healthcare professional. Any or all of the above-described examples may be combined in any suitable manner in various implementations.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A health monitoring computing system, comprising:
a data interface configured to receive appointment data and health tracking data, the health tracking data including biometric data measured by one or more biometric sensors worn by a user;
health-scheduling logic configured to determine that the user is to see a healthcare professional within a threshold period of time based at least on computer analysis of the appointment data;
appointment-optimization logic configured to generate a list of diagnosis-relevant health information based at least on computer analysis of the health tracking data; and
an output device configured to present the list to the user for editing prior to an appointment with the healthcare professional.

2. The health monitoring computing system of claim 1, wherein the appointment data is received from a first device executing one or more of a calendar application, an email application, a messaging application, and a phone application.

3. The health monitoring computing system of claim 2, herein the list of diagnosis-relevant health information comprises only diagnosis-relevant health information determined to be relevant for the user based on computer analysis of one or more of user demographics, historical health data for the user, and user preferences.

4. The health monitoring computing system of claim 1, wherein the health-scheduling logic is further configured to determine a type of the healthcare professional based at least on computer analysis of the appointment data.

5. The health monitoring computing system of claim 4, wherein the list of diagnosis relevant health information comprises only diagnosis-relevant health information determined to be relevant for the determined type of healthcare professional that the user is to see.

6. The health monitoring computing system of claim 1, wherein the data interface is further configured to receive health information from one or more external services, and wherein the health tracking data includes travel location data measured by one or more location sensors associated with the user.

7. The health monitoring computing system of claim 6, wherein the computer analysis of the health tracking data includes comparing a travel location from the travel location data with health information associated with the travel location.

8. On a health monitoring computing system, a method comprising:
receiving, via a data interface of the health monitoring computing system, appointment data and health tracking data;
determining, with health-scheduling logic of the health monitoring computing system, that a user is to see a healthcare professional within a threshold period of time based at least on computer analysis of the appointment data;
generating, with appointment-optimization logic of the health monitoring computing stem, a list of diagnosis-relevant health information based at least on computer analysis of the health tracking data; and
presenting, with an output device of the health monitoring computing system, the list to the user for editing prior to or during an appointment with the healthcare professional.

9. The method of claim 8, further comprising receiving, via a data interface of the health monitoring computing system, health information from one or more external services, and wherein the health tracking data includes travel location data measured by one or more location sensors associated with the user.

10. The method of claim 9, wherein the computer analysis of the health tracking data includes comparing a travel location from the travel location data with health information associated with the travel location.

11. The method of claim 8, further comprising determining a type of healthcare provided by the healthcare professional based at least on computer analysis of the appointment data.

12. The method of claim 11, wherein the computer analysis of the health tracking data includes determining targeted diagnosis-relevant health information that is relevant to the determined type of healthcare provided by the healthcare professional, and wherein the list of diagnosis-relevant health information comprises the targeted diagnosis-relevant health information.

13. The method of claim 8, further comprising removing selected diagnosis-relevant health information from the list based at least on receiving user input requesting removal of the selected diagnosis-relevant health information.

14. The method of claim 8, further comprising adding diagnosis-relevant health information to the list based at least on receiving user input requesting addition of the diagnosis-relevant health information.

15. The method of claim 8, further comprising receiving user input selecting diagnosis-relevant health information and displaying additional information regarding the selected diagnosis-relevant health information.

16. The method of claim 15, wherein the additional information includes measured sensor data that, upon computer analysis, was determined to indicate the selected diagnosis-relevant health information.

17. The method of claim 16, wherein the additional information includes a comparison of the measured sensor data to one or more of historical data for the user and average data for a plurality of other users.

18. A health monitoring computing system, comprising:
a data interface configured to receive appointment data for a user, health tracking data for the user, and health trend data for a plurality of other individuals, the health tracking data including biometric data measured by one or more biometric sensors worn by a user and travel location data measured by one or more location sensors associated with the user;
health-scheduling logic configured to determine that a user is to see a healthcare professional within a threshold period of time and to determine a type of the healthcare professional based at least on computer analysis of the appointment data;
appointment-optimization logic configured to generate a list diagnosis-relevant health information determined to be relevant for the determined type of healthcare professional that the user is to see based at least on computer analysis of the health tracking data, the computer analysis of the health tracking data including comparing a travel location from the travel location data with health information associated with the travel location; and
an output device configured to present the list prior to or during an appointment with the healthcare professional.

19. The health monitoring computing system of claim 18, wherein the data interface is further configured to transmit the list to a healthcare professional device.

20. The health monitoring computing system of claim 19, wherein the list is visually presented including a first view of the diagnosis-relevant information when presented to the user and wherein the list is visually presented including a second, different view of the diagnosis-relevant information when presented to the healthcare professional.
